(19) United States
(12) Patent Application Publication
(10) Pub. No.: US 2026/0046250 A1
(43) Pub. Date: Feb. 12, 2026

(54) STREAMLINED ROUTING TO HOST SERVERS IN CONTAINER NETWORKING ENVIRONMENTS

(71) Applicant: Cisco Technology, Inc., San Jose, CA (US)

(72) Inventors: Clarence Filsfils, Brussels (BE); Pablo Camarillo Garvia, Madrid (ES); Ketan Jivan Talaulikar, Pune, Maharashtra (IN); Ahmed Mohamed Ahmed Abdelsalam, L'Aquila (IT)

(21) Appl. No.: 18/796,913

(22) Filed: Aug. 7, 2024

(51) Int. Cl. H04L 45/748; H04L 45/02; H04L 45/741

(52) U.S. Cl. CPC H04L 45/748; H04L 45/04; H04L 45/741

(57) ABSTRACT

This disclosure describes techniques and mechanisms to enable streamlined and simplified connectivity to host servers in data centers that utilize automated containerized networking. The techniques may be used individually or together to provide a fully automated, plug-and-play experience for the advertisement and discovery of IPv6 prefixes, simplify IPv6 routing to host servers, and provide reachability, visibility, and liveness detection. The techniques may eliminate the need for a BGP stack. The techniques may include extending a link layer discovery protocol stack running on a server to support adding a new TLV to LLDP probes sent to a top of rack router. The new TLV may advertise identifier(s) of the server (e.g., SRv6 Locator, IPv6 prefix(es), IPv4 prefix(es), etc.). The ToR may learn the identifier(s) of the server and may redistribute the server’s reachability using routing protocol(s) of the network.

### TECHNICAL FIELD

The present disclosure relates generally to the field of container networking, and more particularly to techniques for enabling streamlined routing to host servers in a data center that utilizes automated container networking.

### BACKGROUND

Computer networks are generally a group of computers or other devices that are communicatively connected and use one or more communication protocols to exchange data, such as by using packet switching. For instance, computer networking can refer to connected computing devices (such as laptops, desktops, servers, smartphones, and tablets) as well as an ever-expanding array of Internet-of-Things (IoT) devices (such as cameras, door locks, doorbells, refrigerators, audio/visual systems, thermostats, and various sensors) that communicate with one another. Modern-day networks deliver various types of network architectures, such as Local-Area Networks (LANs) that are in one physical location such as a building, Wide-Area Networks (WANs) that extend over a large geographic area to connect individual users or LANs, virtual extensible LANs (VXLAN), ethernet virtual private networks (EVPNs), Enterprise Networks that are built for a large organization, Internet Service Provider (ISP) Networks that operate WANs to provide connectivity to individual users or enterprises, software-defined networks (SDNs), wireless networks, core networks, cloud networks, and so forth.

These networks often include specialized network devices to communicate packets representing various data from device-to-device, such as switches, routers, servers, access points, and so forth. Each of these devices is designed and configured to perform different networking functions. For instance, switches act as controllers that allow devices in a network to communicate with each other. Routers connect multiple networks together, and also connect computers on those networks to the Internet, by acting as a dispatcher in networks by analyzing data being sent across a network and choosing an optimal route for the data to travel. Access points act like amplifiers for a network and serve to extend the bandwidth provided by routers so that the network can support many devices located further distances from each other.

In a typical data center deployment, virtual machines (VM(s)) may be located in one or more servers. The one or more servers may be located in server racks of the data center. The servers may run containerized workloads, such as Kubernetes or any other type of container workload. In order to ensure connectivity to the servers with containerized workloads, current techniques include installing a border gateway protocol (BGP) stack within each of the servers (e.g., host systems).

However, while the use of BGP stacks on each server is effective at maintaining connectivity, installing BGP stacks on each of the servers introduces complexity in container networking environments, where the deployment and removal of containerized applications can be frequent.

Accordingly, there is a need for a simplified, streamlined, and scalable way to ensure seamless and efficient connectivity to servers in containerized networking environments.

### BRIEF DESCRIPTION OF THE DRAWINGS

The detailed description is set forth below with reference to the accompanying figures. In the figures, the left-most digit(s) of a reference number identifies the figure in which the reference number first appears. The use of the same reference numbers in different figures indicates similar or identical items. The systems depicted in the accompanying figures are not to scale and components within the figures may be depicted not to scale with each other.

FIG. 1 illustrates a system-architecture diagrams of an environment in which streamlined and simplified routing to host servers in a data center is supported.

FIG. 2 illustrates exemplary communications between a server and ToRs, in accordance with the system and techniques described in FIG. 1.

FIGS. 3A and 3B illustrate exemplary fields that may be included in a probe, in accordance with the system and techniques described in FIGS. 1 and 2.

FIG. 4 illustrates a flow diagram of an example method for learning identifiers and redistributing advertisements to a network.

FIG. 5 illustrates a flow diagram of an example method for utilizing an extended LLDP to advertise identifiers of a server.

FIG. 6 illustrates a computing system diagram illustrating a configuration for a data center that can be utilized to implement aspects of the technologies disclosed herein.

FIG. 7 is a computer architecture diagram showing an illustrative computer hardware architecture for implementing a server device that can be utilized to implement aspects of the various technologies presented herein.

### DESCRIPTION OF EXAMPLE EMBODIMENTS

### OVERVIEW

The present disclosure relates generally to the field of container networking, and more particularly to techniques for enabling streamlined routing to host servers in a data center that utilizes automated container networking.

A method to perform techniques described herein, where the method may be implemented by a networking device a network. In some examples, the method may comprise receiving, from a server within the network, a first probe comprising first information associated with the server, the first information including one or more first prefixes. The method may include storing, in memory of the network device, the first information in association with the server. The method may also include generating, based on the first information, an advertisement indicating reachability of the server. The method may further include advertising the reachability of the server to one or more other network devices, the advertisement including the one or more first prefixes.

Another method to perform techniques described herein may be implemented by a server of a data center of a network. The method may include determining, by the server, one or more prefixes associated with the server. The method may include generating, by the server, a probe comprising information associated with the server, the information including the one or more prefixes. The method may further include sending, by the server and based on a time interval, the probe to a first network device and a second network device, wherein the first network device and the second network device redistribute the information to the network.

Additionally, the techniques described herein may be performed by a system and/or device having non-transitory computer-readable media storing computer-executable instructions that, when executed by one or more processors, performs the method described above.

### EXAMPLE EMBODIMENTS

Computer networks are generally a group of computers or other devices that are communicatively connected and use one or more communication protocols to exchange data, such as by using packet switching. For instance, computer networking can refer to connected computing devices (such as laptops, desktops, servers, smartphones, and tablets) as well as an ever-expanding array of Internet-of-Things (IoT) devices (such as cameras, door locks, doorbells, refrigerators, audio/visual systems, thermostats, and various sensors) that communicate with one another. Modern-day networks deliver various types of network architectures, such as Local-Area Networks (LANs) that are in one physical location such as a building, Wide-Area Networks (WANs) that extend over a large geographic area to connect individual users or LANs, virtual extensible LANs (VXLAN), ethernet virtual private networks (EVPNs), Enterprise Networks that are built for a large organization, Internet Service Provider (ISP) Networks that operate WANs to provide connectivity to individual users or enterprises, software-defined networks (SDNs), wireless networks, core networks, cloud networks, and so forth.

These networks often include specialized network devices to communicate packets representing various data from device-to-device, such as switches, routers, servers, access points, and so forth. Each of these devices is designed and configured to perform different networking functions. For instance, switches act as controllers that allow devices in a network to communicate with each other. Routers connect multiple networks together, and also connect computers on those networks to the Internet, by acting as a dispatcher in networks by analyzing data being sent across a network and choosing an optimal route for the data to travel. Access points act like amplifiers for a network and serve to extend the bandwidth provided by routers so that the network can support many devices located further distances from each other.

In a typical data center deployment, virtual machines (VM(s)) may be located in one or more servers. The one or more servers may be located in server racks of the data center. The servers may run containerized workloads, such as Kubernetes or any other type of container workload. In order to ensure connectivity to the servers with containerized workloads, current techniques include installing a border gateway protocol (BGP) stack within each of the servers (e.g., host systems).

However, while the use of BGP stacks on each server is effective at maintaining connectivity, installing BGP stacks on each of the servers introduces complexity in container networking environments, where the deployment and removal of containerized applications can be frequent. For instance, installing and using a BGP stack on every host (e.g., server) presents challenges including resource overhead, dependency on host software, increased attack surface, operational overhead, scalability challenges, and limited flexibility. These challenges are further magnified in a containerized networking environment (e.g., such as a Kubernetes environment), where the deployment and removal of containerized applications can occur frequently.

Accordingly, there is a need for a simplified, streamlined, and scalable way to ensure seamless and efficient connectivity to servers in containerized networking environments while offering plug-and-play capabilities.

This disclosure describes techniques and mechanisms for enabling streamlined routing to host servers in data centers that utilize automated container networking. For instance, the techniques may be implemented by a networking device of the network, such as by a router corresponding to a top of rack (ToR). In some examples, the techniques may comprise receiving, from a server within the network, a first probe comprising first information associated with the server, the first information including one or more first prefixes. The techniques may include storing, in memory of the network device, the first information in association with the server. The techniques may also include generating, based on the first information, an advertisement indicating reachability of the server. The techniques may further include advertising the reachability of the server to one or more other network devices, the advertisement including the one or more first prefixes.

Additionally, the techniques may be implemented by a server of a data center of a network. The techniques may include determining, by the server, one or more prefixes associated with the server. The techniques may include generating, by the server, a probe comprising information associated with the server, the information including the one or more prefixes. The techniques may further include sending, by the server and based on a time interval, the probe to a first network device and a second network device, wherein the first network device and the second network device redistribute the information to the network.

In some examples, the network may comprise a service network. In some examples, the network may correspond to a data center that implements a containerized networking environment, such as Kubernetes or any other environment that utilizes containerized applications or containerized networking.

In some examples, the system may utilize a Link Layer Discovery Protocol (LLDP). For instance, the server(s) and the router(s) may be connected via LLDP sessions. The server(s) may send LLDP probe(s) to the router(s). In some examples, the system may extend the LLDP by defining a new type-length-value (TLV) that is generated by the servers and inserted into LLDP probes sent between the host servers and top of racks (ToRs) (e.g., routers). In some examples, the TLV may comprise identifiers of a server. The identifiers may correspond to a SRv6 Locator, an IPv6 prefix, an IPv4 prefix, etc. For instance, where the identifier comprises a SRv6 Locator, each VM, application, container, etc. running on the server may be allocated a SRv6 segment identifier (SID) that is included in the SRv6 Locator. In some examples, the identifier of the server is assigned to the server via an automated orchestration mechanism, such as Kubernetes or other mechanism.

In some examples, the system may comprise VM(s), containers, applications, etc. installed on each server in the data center. In some examples, each individual VM, container, application, etc. may be allocated a SID. In some examples, each SID is located within the identifier of the server (e.g., the SRv6 Locator, IPv6 prefix, IPv4 prefix, etc.). In some examples, each SID corresponds to a prefix that identifies a particular VM, container, application, etc. running on a particular server. In some examples, the LLDP probes may comprise the identifier of the server (and the corresponding SIDs).

In some examples, the system may utilize LLDP protocol to perform liveliness detection. With existing techniques, LLDP has not generally been used for liveliness detection. Instead, other protocols (e.g., bidirectional forwarding detection (BFD), etc.) have been installed and run on both the server(s) and ToR(s) in order to detect liveliness between the ToR(s) and the server(s). Unlike existing techniques, the system may extend the LLDP to provide liveliness detection without the need for another protocol to be installed, run, and maintained within the network. For instance, the system may reduce a “hold timer” field of the LLDP probes to a minimum value and may send the LLDP probes at a predetermined time interval (e.g., a frequent rate, such as every 1ms for Linux systems). The ToR(s) may then detect when the probe(s) from a server are no longer being received at the predetermined time interval and/or after the hold time has expired. Accordingly, the system may utilize the LLDP protocol as a liveliness detection mechanism that enables a server to automate a fast switchover of the connection from a first ToR to a second ToR where the connection to the first ToR suddenly fails. Similarly, the first ToR may automate a fast switchover of the connection to the server to another ToR, where the ToR determines the connection has failed.

In some examples, the system may further extend LLDP to carry additional metadata for application-based policies. For instance, the LLDP probes may be extended via the TLV and/or an additional TLV to carry metadata associated with the applications. For instance, the additional metadata may include information such as version(s) of a container network interface (CNI), a Linux kernel version, SRv6 capabilities of the server, or any other information that may be useful in creating application-based policies. In existing container networking environments, the network may not know what application or function is running on a container in a containerized networking environment. For instance, in Kubernetes, building application-based policies can be very complex, as there is no mechanism that exists to pass information about the containers and applications from Kubernetes to the network. Accordingly, by further extending the LLDP protocol to include additional metadata, the system may be provide a mechanism that enables the network to have access to this information and thus, be able to build application based policies for the network. For instance, the application-based policies may include restraint(s) or restriction(s) that are to be used for a particular set of application(s) running in the containerized networking environment. The policies may further comprise access-based policies, or any other suitable type of policy. As an example, and not by way of limitation, a container may host an employee database for a company. By utilizing the additional metadata, the system may enable the company to specify and/or allow particular groups of employees (e.g., enable employees that are part of the Human Resources department) to have access to the container. Thus, by further extending the LLDP protocol, the system may enhance network management, improving its efficiency and responsiveness to changing networking needs.

In this way the system extends the Link Layer Discovery Protocol (LLDP), defining a new TLV to signal an SRv6 Locator installed on the server. That is, unlike existing techniques, the system may enable each server to advertise its SRv6 Locator as part of regular LLDP messages, thereby reducing complexity and resource overhead. Moreover, by extending LLDP at the server, the system removes the need to install and maintain a BGP stack on each server in the network. Further, by enabling the ToRs to receive the advertisement and redistributes the reachability to the server’s identifier through the routing protocols (dual redistribution on the provider edge router into intermediate system to intermediate system (ISIS), open shortest path first (OSPF), and/or BGP), the system simplifies IPv6 routing to the host, providing reachability, visibility, and liveness detection.

Moreover, the system may provide seamless integration into containerized networking environments, such as Kubernetes. That is, the system may utilize Kubernetes to automate the provisioning of LLDP, which, along with extending the LLDP protocol to incorporate the new TLV, may provide a fully automated, plug-and-play experience for the advertisement and discovery of IPv6 prefixes. Thus, the system may significantly reduce the manual overhead typically associated with traditional routing protocols, making it particularly advantageous in dynamic, containerized data center networks.

Certain implementations and embodiments of the disclosure will now be described more fully below with reference to the accompanying figures, in which various aspects are shown. However, the various aspects may be implemented in many different forms and should not be construed as limited to the implementations set forth herein. The disclosure encompasses variations of the embodiments, as described herein. Like numbers refer to like elements throughout.

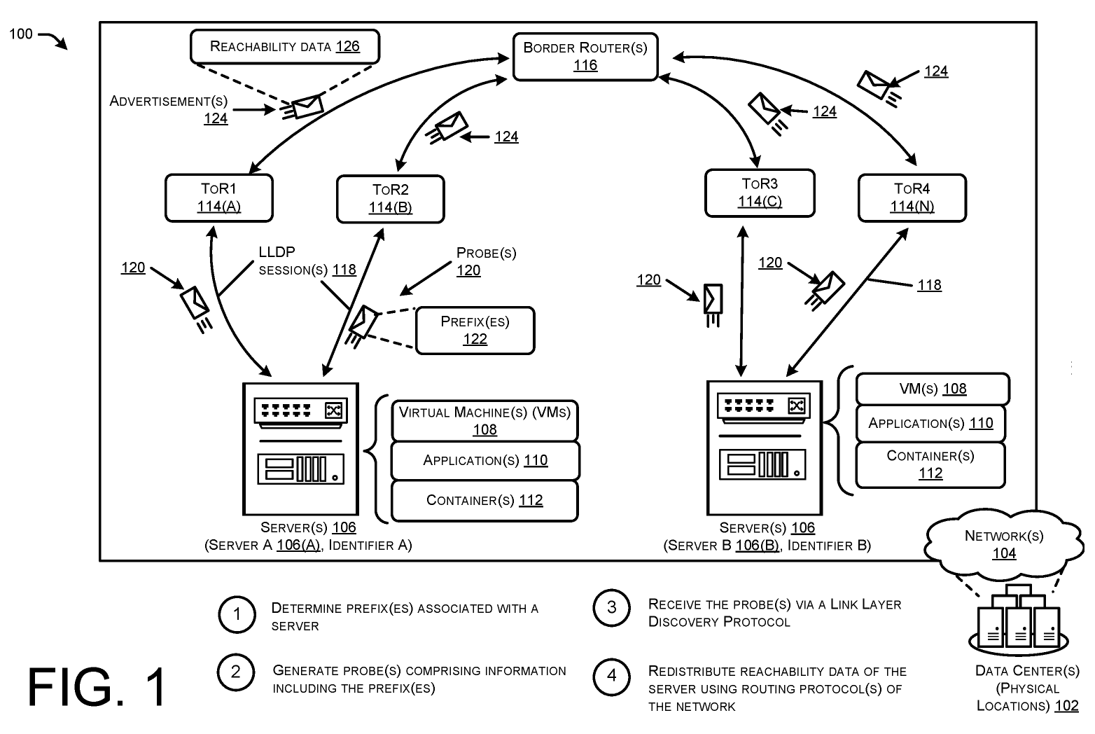

FIG. 1 illustrates a system-architecture diagrams of an environment 100 in which streamlined routing to host servers in a data center is supported. While the examples described below may reference SRv6 Locators, it is understood that the techniques described herein may apply to any IP fabric (e.g., IPv6, IPv4, etc.).

In some examples, the environment 100 may include a network 104 associated with one or more data center(s) 102. The network(s) 104 may correspond to a service network and may include devices housed or located in one or more data centers. The network may include one or more networks implemented by any viable communication technology, such as wired and/or wireless modalities and/or technologies. The network may include any combination of Personal Area Networks (PANs), Local Area Networks (LANs), Wireless LANs, Virtual Private Network(s) (VPNs), Cloud networks, Campus Area Networks (CANs), Metropolitan Area Networks (MANs), extranets, intranets, the Internet, short-range wireless communication networks (e.g., ZigBee, Bluetooth, etc.), Wide Area Networks (WANs) – both centralized and/or distributed – and/or any combination, permutation, and/or aggregation thereof. The network may include devices, virtual resources, or other nodes that relay packets from one network segment to another by nodes in the computer network. The network may include multiple devices that utilize the network layer (and/or session layer, transport layer, etc.) in the OSI model for packet forwarding, and/or other layers. In some examples, the network(s) 104 may correspond to a network that supports containerized networking.

The data center(s) 102 may correspond to one or more data centers. The one or more data centers 102 may be physical facilities or buildings located across geographic areas that designated to store networked devices that are part of a manufacturer. The data centers 102 may include various network devices, as well as redundant or backup components and infrastructure for power supply, data communications connections, environmental controls, and various security devices. In some examples, the data centers may include one or more virtual data centers which are a pool or collection of cloud infrastructure resources specifically designed for enterprise needs, and/or for cloud-based service provider needs. Generally, the data centers (physical and/or virtual) may provide basic resources such as processor (CPU), memory (RAM), storage (disk), and networking (bandwidth). However, in some examples the devices in the packet-forwarding networks may not be located in explicitly defined data centers, but may be located in other locations or buildings. In some examples, the data center(s) comprise network device(s), which may correspond to any computing device, routers, switches, computers, or any other type of network device.

In some examples, the network 104 comprises a network fabric. For instance, the network 104 may comprise a fabric of one or more spine(s) (e.g., such as border router(s) 116) and one or more leaf(s) (e.g., such as ToRs 114) (illustrated as, but not limited to ToR1 114A, ToR2 114B, ToR3 114C, and ToR4 114N).

In some examples, the environment 100 may comprise server(s) 106. In some examples, the server(s) 106 may comprise virtualized server(s). In some examples, the network 104 may comprise a plurality of server(s) 106 associated with a plurality of location(s). For instance, the server(s) 106 may correspond to one or more server racks associated with one or more location(s) within the data center 102 and/or network 104. For instance, server A 106A may correspond to a first location and server B 106B may correspond to a second, different location.

In some examples, each server 106 may comprise one or more virtual machine(s) (VM(s) 108), a hypervisor (not illustrated), application(s) 110, and/or container(s) 112. In some examples, each server 106 may be assigned a unique identifier. For instance, in a containerized networking environment, a first server, such as server A 106A, may be assigned a first identifier (e.g., identifier A) and a second server, such as server B 106B may be assigned a second identifier (e.g., identifier B). For instance, identifier A may correspond to an SRv6 Locator, an IPv6 prefix, or an IPv4 prefix. For instance, an operator of the network 104 (e.g., such as a network administrator) may utilize mechanisms (e.g., such as Kubernetes) for the orchestration and deployment of applications as VM(s) or containers on the servers 106, which may also include the allocation of IP prefixes (including SRv6 Locators) to those servers 106. For instance, each of applications 110, containers 112, and/or VM(s) 108 that are executing on server A 106A may be assigned individual prefixes (e.g., such as SIDs), which may be included as part of identifier A. Similarly, VM(s) 108, applications 110, and container(s) 112 that are executing on server B 106B may be assigned individual prefixes (e.g., such as SIDs) that may be incorporated as part of identifier B. For instance, each of the VM(s) 108, applications 110, and containers 112 that are executing on the second server may be allocated a prefix (e.g., such as a SID) within the SRv6 Locator (e.g., identifier B) of server B 106B. In some examples, the VM(s) 108, applications 110, and containers 112 executing on server A 106A may be different from the VM(s) 108, applications 110, and containers 112 executing on server B 106B. Accordingly, identifier A of server A 106A may identify the reachability of each VM, application, and/or container running at the first server.

In some examples, the hypervisor may act as a virtual switch (e.g., a software-based network switch that operates within a virtualized environment). In some examples, the ToR(s) 114 are configured to route network traffic (e.g., such as IP address(es), including IPv4 and IPv6 addresses) to a corresponding VM, application, and/or container running at a particular server. In some examples, each ToR 114 may comprise a network device, such as a router, a switch, or any other suitable network device. In some examples, the ToRs 114 may comprise a router, such as Cisco’s IOS XR router, or a SONiC router).

In some examples, each server 106 may be configured to communicate with one or more ToRs 114. For instance, each server 106 may be dual connected to two ToRs 114 (such as ToR1 114A and ToR2 114B), such as via LLDP session(s) 122. In some examples, the server(s) 106 may be configured to send probe(s) 120 to the ToR(s) 114. For instance, the server(s) 106 may be configured to send the probe(s) 120 at a predefined time interval. In some examples, the probe(s) 120 may comprise LLDP probes. In some examples, the LLDP probes may comprise information including interface identifiers, host identifiers, and/or other properties associated with a host server. However, in existing LLDP, the LLDP probes do not include prefix(es) 122. Thus, in some examples, the LLDP probes may be extended to include prefix(es) 122. Prefix(es) 122 may comprise one or more of the identifier of the server (e.g., identifier A) and/or one or more prefix(es) associated with individuals of the VM(s) 108, application(s) 110, and/or container(s) 112. For instance, the prefix(es) may include an SRv6 Locator of a particular server.

In some examples, the ToRs 114 may be configured to send advertisement(s) 124 that include reachability data 126 to the border router(s) 116 and/or other network devices in the network 104. In some examples, the reachability data 126 may comprise IP address(es), MAC address(es), and/or information regarding whether a particular virtual machine can receive traffic at the particular server. In some examples, the reachability data 126 may comprise the identifier of the particular server (e.g., the SRv6 Locator). As noted above, the identifier may comprise one or more prefix(es) associated with the VM(s) 108, application(s) 110, and/or container(s) 112 running on the particular server. As an example, and not by way of limitation, the identifier may comprise an SRv6 Locator where the prefix(es) 122 associated with the VM(s) 108, applications 110, and/or containers 112 are each allocated a SRv6 SID within the SRv6 Locator.

In some examples, the ToR(s) 114 may determine a routing protocol utilized by the network 104. For instance, the ToR(s) 114 may determine that the network 104 utilizes ISIS, OSPF, or BGP, etc.. The ToR(s) 114 may insert the identifier of the particular server into a local routing information base of the ToR and may redistribute the identifier to the rest of the network using the routing protocol (e.g., IGP/BGP, ISIS, OSPF, or any other suitable routing protocol).

At “1”, the system may determine prefix(es) associated with a server. For instance, the system may determine SIDs of VM(s) 108, application(s) 110, and/or container(s) 112. The system may determine a prefix assigned to the server (e.g., such as identifier A or identifier B)

At “2”, the system may generate a probe comprising the prefix(es). For instance, the server(s) 106 may generate a probe 120, such as an LLDP probe. The probe 120 may comprise the prefix(es) 122. For instance, the probe 120 may be extended to incorporate a TLV field that includes the prefix(es) 122. The server(s) 106 may send the probe(s) 120 at predetermined time intervals. For instance, the time interval may be set by a network administrator and/or based on hardware of the server. For instance, a server 106 that executes in Linux may generate an LLDP probe every 1ms.

At “3”, the system may receive the probe(s) via a link layer discovery protocol (LLDP) session. For instance, the ToRs 114 may receive the probe(s) 120. The ToR(s) 114 may be configured to parse the probes and may determine the prefix(es) associated with the server. As illustrated, the server(s) 106 may be dual connected to the ToR(s) 114. Accordingly, if the connection between server 106 and ToR1 114A goes does, traffic may still reach the server 106 via ToR2 114B. In some examples, the ToR(s) 114 may store the prefix(es) associated with the server(s) 106 in a local routing information database.

At “4”, the system may redistribute reachability data of the server using routing protocol(s) of the network. For instance, the ToR(s) 114 may determine the routing protocol(s) used by the network 104. The ToR(s) 114 may then advertise the reachability data 126 of the server(s) using the routing protocol(s) (e.g., BGP, ISIS, OSPF, etc.). For instance, the reachability data 126 may comprise the prefix(es) 122.

In this way, system extends the LLDP and defines a new TLV to signal an SRv6 Locator (or other IPv6 or IPv4 prefix) installed on the server. That is, unlike existing techniques, the system may enable each server to advertise its SRv6 Locator as part of regular LLDP messages, thereby reducing complexity and resource overhead. Moreover, by extending the LLDP stack running at the server, the system removes the need to install and maintain a BGP stack on each server in the network. Further, by enabling the ToRs to receive the advertisement and redistributes the reachability to the server’s identifier through the routing protocols (dual redistribution on the provider edge router into intermediate system to intermediate system (ISIS), open shortest path first (OSPF), and/or BGP), the system simplifies IPv6 routing to the host, providing reachability, visibility, and liveness detection.

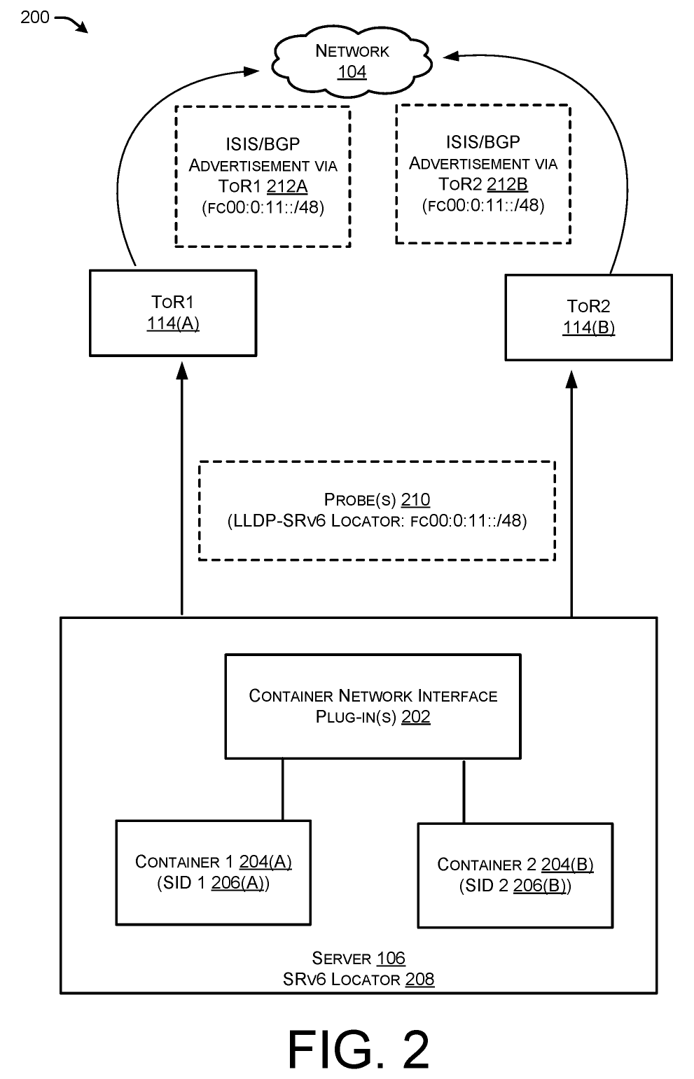

FIG. 2 illustrates an environment 200 with exemplary communications between a server and ToRs, in accordance with the system and techniques described in FIG. 1. In some examples, the example environment 200 illustrated in FIG. 2 corresponds to a data center that utilizes an automated container networking, such as Kubernetes. The example environment 200 of FIG. 2 is also described as implementing SRv6. However, the example environment 200 described in FIG. 2 is not meant to be limiting. It is understood that the techniques described herein may apply to any container networking environment and/or may apply to any IP networking.

As illustrated in FIG. 2, the example environment 200 may include a server 106, ToR1 114A, ToR2 114B, and network 104. In addition to the components described in FIG. 1, the server 106 may comprise container networking interface (CNI) plug-in(s) 202. For instance, the CNI plug-in(s) 202 may correspond to a Kubernetes CNI that is installed and executing on the server 106. The CNI plug-in(s) 202 may be connected to one or more container(s) executing on the server. For instance, the CNI plug-in(s) 202 may communicate with container 1204A and container 2204B. In some examples, container 1204A and container 2204B may be configured to execute an application, manage a database, or any other function that exists for a container. As illustrated in FIG. 2, container 1204A may be assigned SID 1 206A and container 2 may be assigned SID 2 206B. For instance, each container may be assigned a SID during orchestration performed by Kubernetes. In some examples, the server 106 is also assigned an SRv6 Locator 208. For instance, during provisioning of the server 106 and container(s) (e.g., container 1204A and container 2204B), the server 106 may be allocated an address that is /48 in length. Each SID of the containers (e.g., SID 1206A and SID 2206B) may be allocated within the SRv6 Locator 208.

The server 106 may further comprise a hypervisor (not illustrated) that may behave as a virtual switch. In the illustrated example environment 200, the containers may not have a form of routing control-plane or LLDP extension. Moreover, the services in the containers may be managed in an orthogonal manner through a service registry that is independent.

As illustrated in the example environment 200, the server 106 may be dual connected to two ToRs (e.g., ToR1 114A and ToR2 114B). In some examples, the server 106 may interface with the ToRs by using IPv6 link-local addressing. As noted above, communications between the server 106 and the ToRs traditionally do not include the SRv6 Locator 208 of the server 106 and the SRv6 Locator 208 is traditionally not discoverable by LLDP probes.

In the illustrated example environment 200, the server 106 may determine the SRv6 Locator 208. The server 106 may then generate probe(s) 210. As illustrated, the probe(s) 210 to ToR1 114A and ToR2 114B may contain the SRv6 Locator 208 assigned to the server 106 itself. As described herein, the probe(s) 210 may comprise LLDP probe(s) that are extended to include a TLV field. The TLV field may comprise the SRv6 Locator 208, which includes SID 1206A and SID 2206B of the container(s). As illustrated, the probe 210 may comprise “LLDP-SRv6 Locator: fc00:0:11::/48”.

In some examples, such as where a container or an application on a server goes down or is moved to a different server, the server 106 can update the SRv6 Locator, such that it does not include the SIDs of the container or application(s) that were moved or have lost connection. As an example, the probe(s) 210 may comprise SID 1 206A and SID2 206B as part of the SRv6 Locator 208. In this example, container 1204A may lose connection or be moved to another server in the data center 102. In this example, the prefix associated with container 1204A (e.g., SID 1206A) will stop being advertised by the server 106. Instead, the server 106 will send probe(s) that include the SRv6 Locator 208, which will include the prefix associated with container 2204B (e.g., SID 2206B). In this example, the prefix associated with container 1204A (e.g., SID 1206A or a new SID provisioned by an orchestration mechanism on the other server) may be advertised in other LLDP probes sent from the other server. Accordingly, the server 106 does not preserve the SID allocated to the container or application that is moved. By removing SID 1206A associated with container 1204A, the ToRs (ToR1 114A and ToR2 114B) may remove SID 1 206A from a local routing information base. Further, advertisement(s) from the ToRs will no longer include SID 1206A, indicating to the network that the application can no longer be reached at the server 106. Moreover, once a prefix associated with container 1204A begins being advertised in the LLDP probes from the other server, the network 104 may redirect traffic to the other server.

As illustrated in FIG. 2, ToR1 114A and ToR2 114B may receive the probe(s) 210 from the server 106. As noted above, ToR1 114A and ToR2 114B may comprise Cisco IOS-XR routers. In some examples, the operating system of ToR1 114A and ToR2 114B are extended to enable the ToR1 114A and ToR2 114B to parse the probe(s) 210 and learn the SRv6 Locator 208 from the LLDP probes. ToR1 114A and ToR2 114B may be configured to determine the routing protocol utilized by the network 104. For instance, the routing protocol in the example environment 200 may be ISIS/BGP. Accordingly, ToR1 114A and ToR2 114B may each integrate the SRv6 Locator into ISIS and BGP protocols, and may redistribute advertisements to the network 104 indicating the reachability of the server 106.

For instance, as illustrated in the example environment 200, ToR1 114A may send an ISIS/BGP advertisement 212A to the network 104, where the advertisement includes the SRv6 Locator (e.g., “fc00:0:11::/48”). Similarly, ToR2 114B may send an ISIS/BGP advertisement 212B to the network 104, where the advertisement includes the SRv6 Locator (e.g., “fc00:0:11::/48”). Accordingly, ToR1 114A and ToR2 114B may each advertise in BGP /48 (SRv6 Locator for the LLDP session with each host) with a BGP community that instructs border router(s) 116 (e.g., DCI or Border Spine) to avoid propagation to other domains. For instance, border router(s) 116 may be configured with an aggregate address (say a /40) that they advertise outside the data center 102. Thus, the more specific /48 addresses may be filtered out based on the community. This may reduce route scale and improve convergence within the data center 102. Further, by utilizing a server that is dual connected to ToR1 114A and ToR2 114B, the system may ensure server 106 can still be reached if one of the ToRs goes down. For instance, other domains still route to the data center on the basis of the /40 addresses. Once in the data center 102, the border router 116 may identify a specific route for the /48 address and may forward traffic to the corresponding server through the remaining connected ToR.

Accordingly, the system may provide seamless integration into containerized networking environments, such as Kubernetes. That is, the system may utilize Kubernetes to automate the provisioning of LLDP, which, along with extending the LLDP protocol to incorporate the new TLV, may provide a fully automated, plug-and-play experience for the advertisement and discovery of IPv6 prefixes. Thus, the system may significantly reduce the manual overhead typically associated with traditional routing protocols, making it particularly advantageous in dynamic, containerized data center networks.

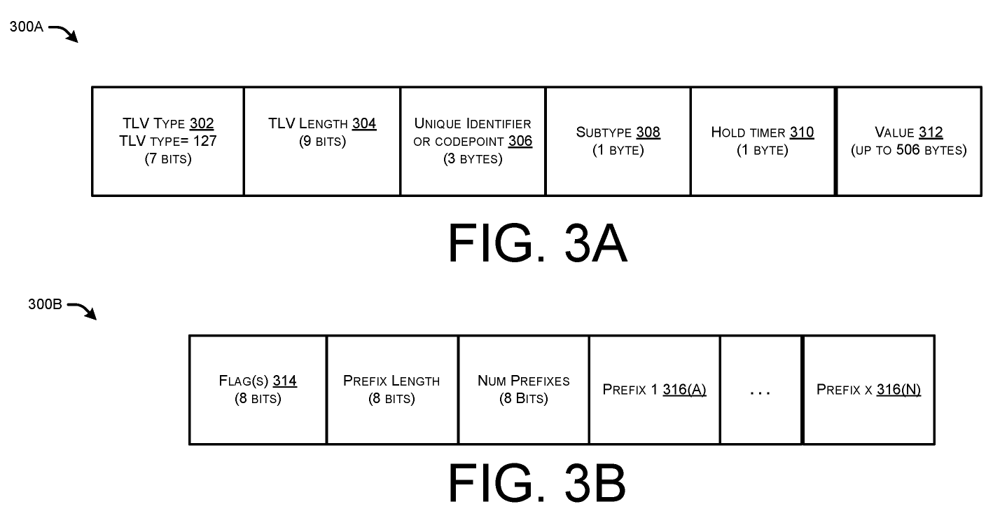

FIGS. 3A and 3B illustrate exemplary fields that may be included in a probe, in accordance with the system and techniques described in FIGS. 1 and 2. The illustrated examples in FIGS. 3A and 3B are examples only. Additional, alternative, or fewer fields may be included.

FIG. 3A illustrates an example of a TLV 300A that may be added to a LLDP probe, such as probe(s) 120 and/or probe(s) 210. For instance, the TLV 300A may be used to advertise the server 106 prefix(es). As illustrated the example TLV 300A may comprise one or more fields, such as TLV type 302, TLV length 304, unique identifier or codepoint 306, subtype 308, hold timer 310, and/or value 312. In some examples, the example TLV 300A represents an expel of encodings included in the TLV as part of the probe(s) 120 and/or probe(s) 210.

As illustrated, the TLV type 302 may have a value (illustrated as “TLV type = 127” and may be 7 bits in length. The value of the TLV type 302 may indicate a vendor specific TLV. The TLV length 304 may comprise 9 bits and may indicate the length of the TLV. The unique identifier or codepoint 306 may comprise 3 bytes. The unique identifier or codepoint 306 may indicate a unique identifier associated with a service provider. For instance, the unique identifier or codepoint 306 may be set to “00 00 0C”, which may correspond to an organizationally unique identifier of a service provider, such as Cisco. In some examples, the unique identifier or codepoint 306 may be set of a value corresponding to a codepoint, such as an IANA codepoint. The subtype 308 may comprise 1 byte and may be set to a value as “subtype=TBD”, where the TBD indicates the next available value. In some examples, the subtype 308 may be a value that is checked internally by a server 106.

The hold timer 310 may comprise 1 byte. The hold timer 310 may be set to a value that indicates a period of time (e.g., in seconds, milliseconds, etc.) for which the ToRs and/or the servers may retain the prefixes without receiving another LLDP PDU carrying the same prefix. The hold timer value may apply to all prefixes in the TLV (e.g., all the prefixes associated with a particular server). In some examples, the ToR may remove prefixes associated with applications, containers, VM(s), etc. of a server from a local routing information base (e.g., such as a local memory or table) automatically when the LLDP session goes down, when the hold timer 310 expires, and/or if the prefix is not present in a subsequent LLDP probe, even where the hold timer 310 is still running. For instance, where a subsequent LLDP probe does not include a prefix that is stored in the local routing information base (e.g., such as a local memory or table), the ToR may automatically remove the prefix from the local routing information base (e.g., such as a local memory or table), regardless of whether the hold timer 310 has expired.

In some examples, the hold timer 310 may be utilized for liveliness detection. For instance, the ToRs may store a SRv6 Locator associated with a server. When the ToRs have not received a subsequent probe that includes the SRv6 Locator and the hold time included in the TLV has expired, the ToRs may remove the SRv6 Locator from the memory. In some examples, a hold time of zero results in immediate removal of the SRv6 Locator state associated with the server. Accordingly, setting the hold time value to a minimal value may enable the LLDP probes to be used for liveliness detection, where the LLDP probes are sent at a frequency supported by hardware of the server(s) 106 (e.g., such as 1ms for Linux). Additionally, where an LLDP session goes down, the ToRs may remove the corresponding SRv6 Locator state.

The value 312 may comprise up to 506 bytes. The value 312 may include a single prefix associated with a server, VM, application, or container. In some examples, the value 312 may comprise one or more prefix blocks. For instance, the value 312 may include multiple prefixes (IPv4, IPv6, etc.) that are encoded as a block of prefixes to optimize the space in the LLDP probe. For instance, the value 312 may comprise one or more prefixes, one after the other. The block(s) of prefixes may be encoded as shown in FIG. 3B below.

In some examples, the ToR(s) 114 and/or border router(s) 116 may utilize summarization techniques in order to reduce and/or prevent scaling issues. For instance, the ToRs in a data center 102 may be connected to hundreds or thousands of servers 106, each of which have their own prefix (e.g., identifier, such as a /48 for SRv6, a /128 for IPv6, a /32, etc.). Instead of trying to push all of the prefixes into routing, which can cause scalability problems, the ToRs 114 and/or border router(s) 116 may utilize summarization, which may include aggregating the prefixes. That is, instead of sending each individual prefix or route into the network, the ToR and/or border router may send a single prefix or route, or a subset of the prefixes or routes into the network at a time.

Moreover, the servers may be configured such that each of the probe(s) 120 and/or probe(s) 210 may comprise different portion(s) of the SRv6 TLVs. For instance, the probe(s) 120 and/or probe(s) 210 may not include every SRv6 TLV. Instead, the probe(s) 120 and/or probe(s) 210 may contain respective portions of the SRv6 TLVs. In this example, the system may allow for the carrying of a larger set of information than what a LLDP probe generally allows, without complex fragmentation and re-assembly logic being required. It also keeps the LLDP probes lightweight for faster liveliness detection.

FIG. 3B illustrates an example of a block of prefixes 300B that may be included in the TLV 300A of FIG. 3A. For instance, the block of prefixes 300B may be included as part of the value 312 field of the TLV 300A, as illustrated in FIG. 3A. As illustrated the example block of prefixes 300B may comprise one or more fields, such as flag(s) 314, prefix length, num prefixes, prefix 1316A, and prefix X 316N.

In some examples, flag(s) 314 may comprise 8 bits (e.g., bit 0 through bit 7), where each flag may apply to every prefix included in the block of prefixes 300B. For example, bit 0 of the flag(s) 314 may be set to a value that indicates whether the block of prefixes 300B includes IPv6 prefixes or IPv4 prefixes. As an example, where the bit 0 flag is set, the block of prefixes 300B may comprise IPv6 prefixes and where the bit 0 flag is clear (e.g., unset), the block of prefixes 300B may comprise IPv4 prefixes. As another example, bit 1 may indicate whether there is a SRv6 Locator. For instance, where the value of bit 1 is set, the block of prefixes 300B may comprise a SRv6 Locator. Where the value of bit 1 is clear (e.g., value is not set), the block of prefixes 300B may comprise any other non-IPv6 prefixes.

The prefix length may comprise 8 bits and may indicate the length of all of the prefixes included in the block of prefixes 300B. The num prefixes may comprise 8 bits and may indicate the number of prefixes included in the block of prefixes 300B.

Prefix 1316A may indicate the start of the prefix block (e.g., the value 312) and may comprise a first prefix, where the prefix block ends with prefix X 316N. Each prefix (e.g., prefix 1316A, …, prefix X 316N) may contain one of an IPv4 prefix or an IPv6 prefix followed by the minimum number of trailing bits needed to make the end of the prefix fall on an octet boundary. In some examples, the trailing bits are set to 0. Thus, the most significant octets of each of the prefixes in the prefix block may be encoded and the trailing bits may be omitted.

In this way, the examples shown in FIGS. 3A and 3B provide exemplary ways of encoding and defining an SRv6 TLV. By defining an SRv6 TLV, the system may simplifying the process of distributing and discovering IPv6 prefixes, offering a plug-and-play solution for modern networking needs. Further, the system may introduce a flexible framework that enables users to establish rules for processing information included in the probe(s). This flexibility enables the system to efficiently manage how SRv6 Locators and/or prefix(es) are updated or withdrawn. In addition to these benefits, the exemplary encodings may seamlessly be integrated with existing deployment workflows without imposing new constraints or changes.

As noted above, the examples shown in FIGS. 3A and 3B are exemplary ways of encoding the information described above, however, the techniques may apply to any other method of encoding the information.

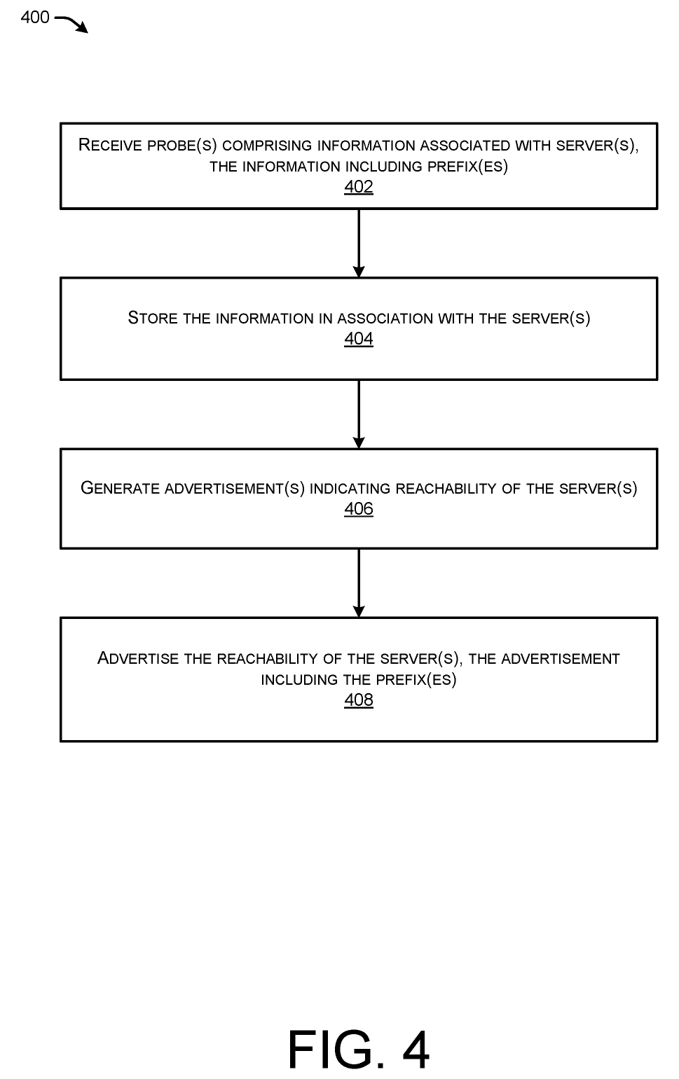

FIG. 4 illustrates a flow diagram of an example method 400 for learning identifiers and redistributing advertisements to a network. In some examples, the method 400 is implemented by and/or associated with a control plane of a network. In some instances, the techniques may be performed by a system (e.g., one or more devices), such as the server(s) 106, ToR(s) 114, border router(s) 116, a combination thereof, and/or any other devices (e.g., hardware offload chips and/or any other device). The techniques of method 400 may be performed by a system that includes one processor, or more than one processor.

At 402, the system may receive probe(s) comprising information associated with server(s), the information including prefix(es). For instance, the system may receive the probe(s) 120 and/or probe(s) 210 via a connection with server(s) 106, where the connection may correspond to LLDP session(s) 118. The probe(s) 120 and/or probe(es) 210 may comprise LLDP probes that are generated on the server(s) 106, where the server(s) 106 are configured to extend the LLDP stack running on the server, in order to support the new TLV to carry the prefix(es) (e.g., SRv6 locator 208, IPv6 prefix(es), IPv4 prefix(es), etc.) from the server(s) 106 to the networking device. In some examples, the network device may comprise a router (e.g., such as a ToR, a Cisco IOS-XR router, etc.). In some examples, the network device may be configured to learn the prefix(es) from the probe(es), such as by parsing the probe(s).

For instance, the system may receive a first probe comprising first information associated with a server and including first prefix(es). In some examples, such as where the first prefix(es) include a SRv6 Locator, the one or more first prefixes may comprise SRv6 SIDs associated with one or more virtual machines, applications, or containers executing on the server.

At 404, the system may store the information in association with the server(s). For instance, the system may store the information in a local routing information base, such as in memory of the network device (e.g., ToR), a default table, a database, etc. In some examples, the system may associate the server(s) with the respective prefix(es). For instance, the system may associate a SRv6 Locator with a particular server.

At 406, the system may generate advertisement(s) indicating reachability of the server(s). For instance, the system may determine the routing protocol(s) (e.g., BGP, ISIS, OSPF, etc.) utilized by the network. The system may generate advertisement(s) using the routing protocol(s), where the advertisement(s) include the learned prefix(es).

At 408, the system may advertise the reachability of the server(s), the advertisement including the prefix(es). For instance, the system may redistribute the advertisement(s) to the network (e.g., the border router(s) 116 and/or outside of the data center(s) 102). Accordingly, the system may provide reachability information to the server, as well as visibility into the container(s), VM(s), application(s), etc. running on the server, such as by including the workload IP address in the advertisement(s). In some examples, advertising comprises redistributing the advertisement via a routing protocol of the network, the routing protocol comprising BGP, OSPF, or ISIS.

In some examples, the system may determine that a second probe has not been received from the server and that a time period associated with the server has expired. For instance, the server may be configured to send LLDP probes at a time interval (e.g., such as every 1 second, 1 millisecond, etc.). The system may determine that a probe has not been received from the server for a particular time period (e.g., such as 3 seconds). In this example, the system may determine that the server is down and the system may update the memory of the network device to remove the one or more first prefixes.

In some examples, the system may receive, from the server, a second probe comprising second information associated with the server, the second information including one or more second prefixes. The system may determine that at least one prefix of the one or more first prefixes is not included in the one or more second prefixes. For instance, the system may determine that one or more SIDs associated with one or more of the VM(s), applications, or containers on the server is not included in the second probe. The system may determine that a time period associated with the server has expired. For instance, the system may determine that the hold timer included in the first probe or the second probe has expired. The system may update the memory of the network device to remove the at least one prefix. For instance, the system may remove the SID, the SRv6 Locator, the IPv6 prefix, and/or the IPv4 prefix from the memory.

In some examples, the system may receive, from the server, a second probe comprising second information associated with the server, the second information including one or more second prefixes. The system may determine that at least one prefix of the one or more first prefixes is not included in the one or more second prefixes. The system may receive, from a second server, a third probe comprising third information, the third information including the at least one prefix. For instance, the system may determine that the SID of a particular container is included in the third probe from the second server. The system may update, based at least in part on the second probe and the third probe, the memory to remove an association between the at least one prefix and the server. The system may store, in the memory, a second association between the at least one prefix and the second server.

In some examples, the system may receive, from one or more second servers, one or more second probes comprising one or more second prefixes. The system may aggregate the one or more first prefixes and the one or more second prefixes to create aggregated prefixes. The system may generate the advertisement, wherein the advertisement comprises at least a portion of the aggregated prefixes.

In this way, the system may enable the ToRs to receive the advertisement and redistribute the reachability to the server’s identifier through the routing protocols utilized by the network (such as dual redistribution on the provider edge router into intermediate system to intermediate system (ISIS), open shortest path first (OSPF), and/or BGP). Thus, the system simplifies IPv6 routing to the host server, providing reachability, visibility, and liveness detection.

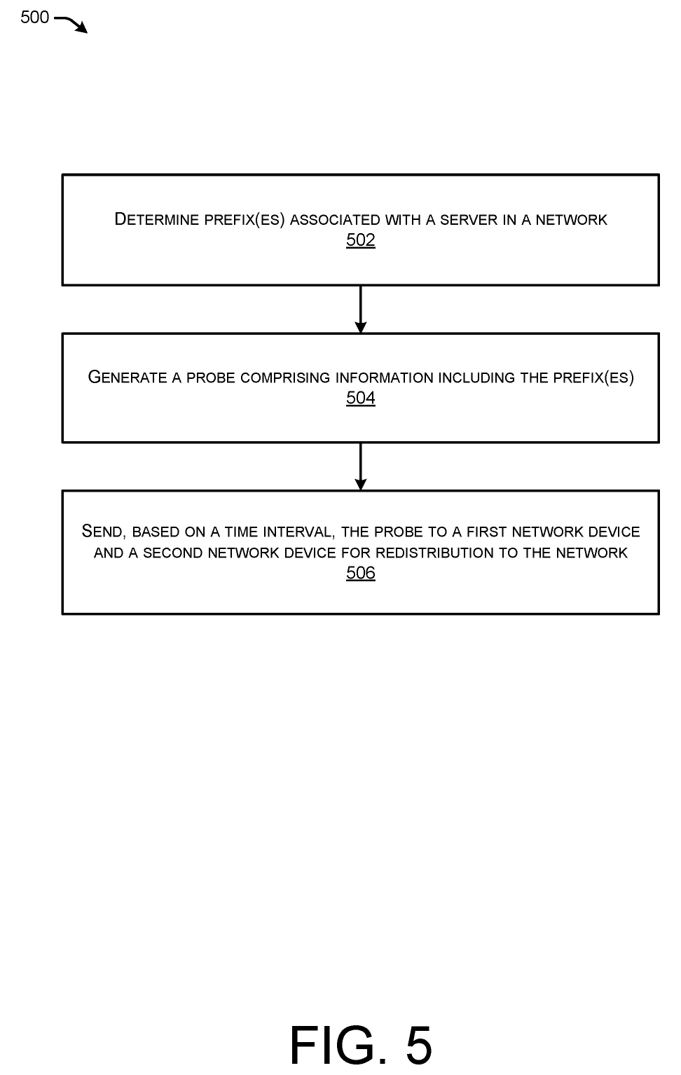

FIG. 5 illustrates a flow diagram of an example method 500 for utilizing an extended LLDP to advertise identifiers of a server. In some instances, one or more of the techniques may be performed by a system (e.g., one or more devices), such as such as the server(s) 106, ToR(s) 114, border router(s) 116, a combination thereof, and/or any other devices (e.g., hardware offload chips and/or any other device). The techniques of method 500 may be performed by a system that includes one processor, or more than one processor.

At 502, the system may determine prefix(es) associated with a server in a network. For instance, the system may be performed by a server within a data center. The server may comprise an extended LLDP stack. The system may be configured to perform discovery of the prefix(es), where the prefix(es) include one or more of an IPv6 prefix, an IPv4 prefix, or an SRv6 Locator. In some examples, the one or more prefixes comprise identifiers (e.g., such as SRv6 SIDs) associated with one or more applications, VM(s), or containers executing on the server.

At 504, the system may generate a probe comprising information including the prefix(es). For instance, the probe may comprise a LLDP probe. In some examples, generating the probe comprises adding a TLV field to the probe, the TLV field including a TLV type, a TLV length, a unique identifier, a hold timer, and the one or more prefixes. In some examples, the one or more prefixes are encoded as a block of prefixes within the probe.

At 506, the system may send, based on a time interval, the probe to a first network device and a second network device for redistribution to the network. In some examples, the first network device and/or the second network device comprise top of rack router(s) that are configured to redistribute the one or more prefixes using one or more routing protocols of the network.

In some examples, the system may determine, after the time interval and by the server, a new prefix associated with a new container or a new application running on the server. For instance, the system may identify a newly provisioned VM, container, or application. The system may determine a prefix associated with the new VM, container, or application. The system may generate a second probe comprising second information, the second information including the new prefix.

In this way, the system may extend the LLDP and define a new TLV to signal an SRv6 Locator (or other IPv6 or IPv4 prefix) installed on the server. That is, unlike existing techniques, the system may enable each server to advertise its SRv6 Locator as part of regular LLDP messages, thereby reducing complexity and resource overhead. Moreover, by extending the LLDP stack running at the server, the system removes the need to install and maintain a BGP stack on each server in the network.

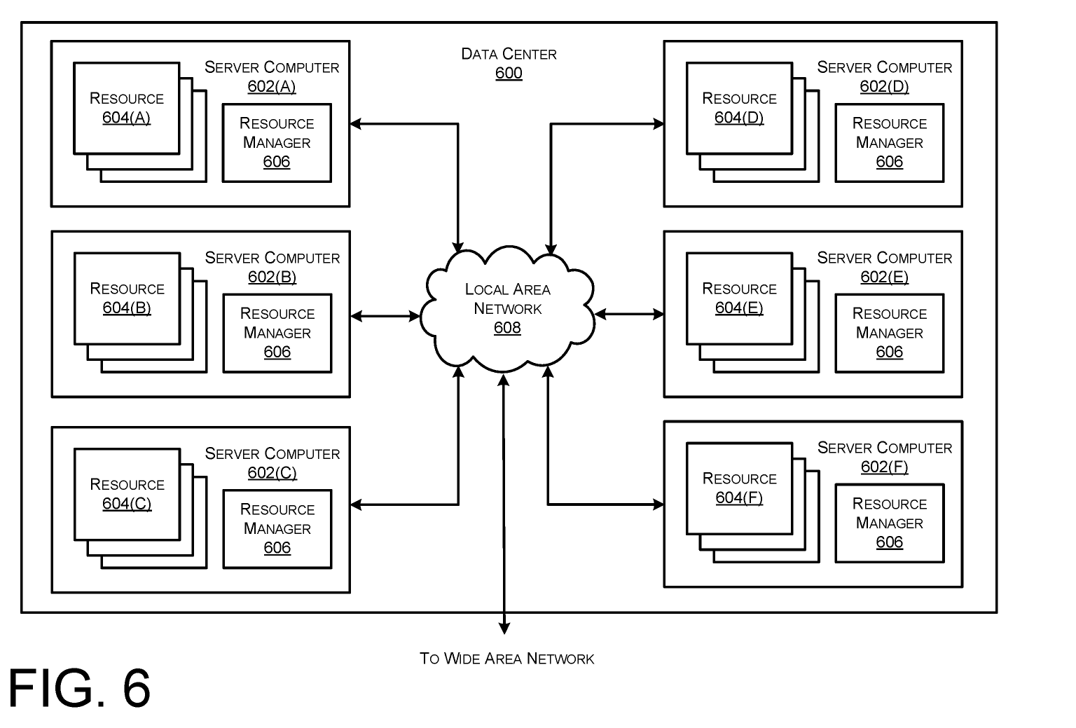

FIG. 6 illustrates a computing system diagram illustrating a configuration for a data center 600 that can be utilized to implement aspects of the technologies disclosed herein. The example data center 600 shown in FIG. 6 includes several server computers 602A-602F (which might be referred to herein singularly as “a server computer 602” or in the plural as “the server computers 602”) for providing computing resources. In some examples, the resources and/or server computers 602 may include, or correspond to, the any type of networked device described herein. Although described as servers, the server computers 602 may comprise any type of networked device, such as servers, switches, routers, hubs, bridges, gateways, modems, repeaters, access points, etc.

The server computers 602 can be standard tower, rack-mount, or blade server computers configured appropriately for providing computing resources. In some examples, the server computers 602 may provide resource(s) 604 (illustrated as resource 604A-604F) including data processing resources such as VM instances or hardware computing systems, database clusters, computing clusters, storage clusters, data storage resources, database resources, networking resources, VPNs, and others. Some of the server computers 602 can also be configured to execute a resource manager 606 capable of instantiating and/or managing the computing resources. In the case of VM instances, for example, the resource manager 606 can be a hypervisor or another type of program configured to enable the execution of multiple VM instances on a single server computer. Server computers 602 in the data center 600 can also be configured to provide network services and other types of services.

In the example data center 600 shown in FIG. 5, an appropriate LAN 608 is also utilized to interconnect the server computers 602A-602F. It should be appreciated that the configuration and network topology described herein has been greatly simplified and that many more computing systems, software components, networks, and networking devices can be utilized to interconnect the various computing systems disclosed herein and to provide the functionality described above. Appropriate load balancing devices or other types of network infrastructure components can also be utilized for balancing a load between data centers 600, between each of the server computers 602A-602F in each data center 600, and, potentially, between computing resources in each of the server computers 602. It should be appreciated that the configuration of the data center 600 described with reference to FIG. 5 is merely illustrative and that other implementations can be utilized.

In some examples, the server computers 602 and or the resources 604 may each execute/host one or more tenant containers and/or virtual machines to perform techniques described herein.

In some instances, the data center 600 may provide computing resources, like tenant containers, VM instances, VPN instances, and storage, on a permanent or an as-needed basis. Among other types of functionality, the computing resources provided by a cloud computing network may be utilized to implement the various services and techniques described above. The resource(s) 604 provided by the cloud computing network can include various types of computing resources, such as data processing resources like tenant containers and VM instances, data storage resources, networking resources, data communication resources, network services, VPN instances, and the like.

Each type of resource 604 provided by the cloud computing network can be general-purpose or can be available in a number of specific configurations. For example, data processing resources can be available as physical computers or VM instances in a number of different configurations. The VM instances can be configured to execute applications, including web servers, application servers, media servers, database servers, some or all of the network services described above, and/or other types of programs. Data storage resources can include file storage devices, block storage devices, and the like. The cloud computing network can also be configured to provide other types of resource(s) 604 not mentioned specifically herein.

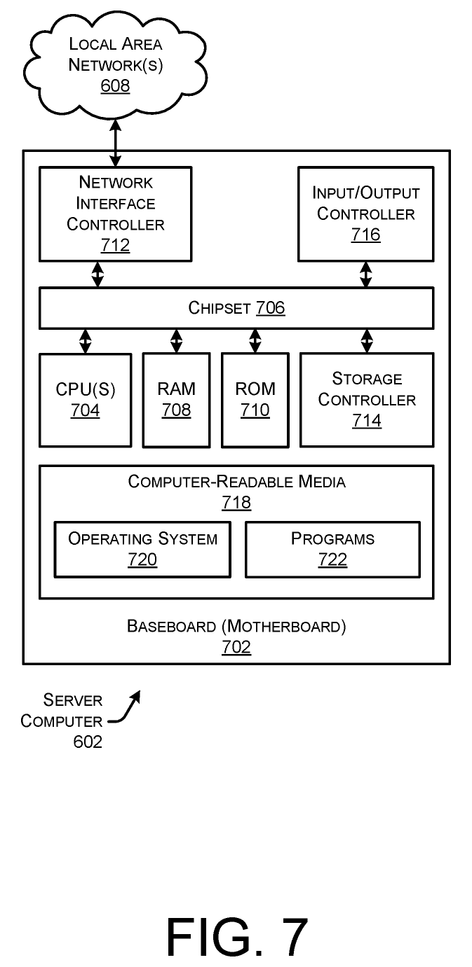

The resource(s) 604 provided by a cloud computing network may be enabled in one embodiment by one or more data centers 600 (which might be referred to herein singularly as “a data center 600” or in the plural as “the data centers 600”). The data centers 600 are facilities utilized to house and operate computer systems and associated components. The data centers 600 typically include redundant and backup power, communications, cooling, and security systems. The data centers 600 can also be located in geographically disparate locations. One illustrative embodiment for a data center 600 that can be utilized to implement the technologies disclosed herein will be described below with regard to FIG. 7.

FIG. 7 illustrates a computer architecture diagram showing an example computer hardware architecture for implementing a computing device that can be utilized to implement aspects of the various technologies presented herein. The computer hardware architecture shown in FIG. 7 illustrates a conventional server computer, such as server computer 602, network device (e.g., ToR 114, border router 116, etc..), workstation, desktop computer, laptop, tablet, network appliance, e-reader, smartphone, or other computing device, and can be utilized to execute any of the software components presented herein. The server computer 602 may, in some examples, correspond to a network device (e.g., ToR 114, server 106, border router 116, etc.) described herein, and may comprise networked devices such as servers, switches, routers, hubs, bridges, gateways, modems, repeaters, access points, etc.

The server computer 602 includes a baseboard 702, or “motherboard,” which is a printed circuit board to which a multitude of components or devices can be connected by way of a system bus or other electrical communication paths. In one illustrative configuration, one or more central processing units (“CPUs”) 704 operate in conjunction with a chipset 706. The CPUs 704 can be standard programmable processors that perform arithmetic and logical operations necessary for the operation of the server computer 602.

The CPUs 704 perform operations by transitioning from one discrete, physical state to the next through the manipulation of switching elements that differentiate between and change these states. Switching elements generally include electronic circuits that maintain one of two binary states, such as flip-flops, and electronic circuits that provide an output state based on the logical combination of the states of one or more other switching elements, such as logic gates. These basic switching elements can be combined to create more complex logic circuits, including registers, adders-subtractors, arithmetic logic units, floating-point units, and the like.

The chipset 706 provides an interface between the CPUs 704 and the remainder of the components and devices on the baseboard 702. The chipset 706 can provide an interface to a RAM 708, used as the main memory in the server computer 602. The chipset 706 can further provide an interface to a computer-readable storage medium such as a read-only memory (“ROM”) 710 or non-volatile RAM (“NVRAM”) for storing basic routines that help to startup the server computer 602 and to transfer information between the various components and devices. The ROM 710 or NVRAM can also store other software components necessary for the operation of the server computer 602 in accordance with the configurations described herein.

The server computer 602 can operate in a networked environment using logical connections to remote computing devices and computer systems through a network, such as the network 104. The chipset 706 can include functionality for providing network connectivity through a Network Interface Controller (NIC) 712, such as a gigabit Ethernet adapter. The NIC 712 is capable of connecting the server computer 602 to other computing devices over the network 104. It should be appreciated that multiple NICs 712 can be present in the server computer 602, connecting the computer to other types of networks and remote computer systems. In some examples, the NIC 712 may be configured to perform at least some of the techniques described herein, such as packet redirects and/or other techniques described herein.

The server computer 602 can be connected to a storage device 718 that provides non-volatile storage for the computer. The storage device 718 can store an operating system 720, programs 722, and data, which have been described in greater detail herein. The storage device 718 can be connected to the server computer 602 through a storage controller 714 connected to the chipset 706. The storage device 718 can consist of one or more physical storage units. The storage controller 714 can interface with the physical storage units through a serial attached SCSI (“SAS”) interface, a serial advanced technology attachment (“SATA”) interface, a fiber channel (“FC”) interface, or other type of interface for physically connecting and transferring data between computers and physical storage units.

The server computer 602 can store data on the storage device 718 by transforming the physical state of the physical storage units to reflect the information being stored. The specific transformation of physical state can depend on various factors, in different embodiments of this description. Examples of such factors can include, but are not limited to, the technology used to implement the physical storage units, whether the storage device 718 is characterized as primary or secondary storage, and the like.

For example, the server computer 602 can store information to the storage device 718 by issuing instructions through the storage controller 714 to alter the magnetic characteristics of a particular location within a magnetic disk drive unit, the reflective or refractive characteristics of a particular location in an optical storage unit, or the electrical characteristics of a particular capacitor, transistor, or other discrete component in a solid-state storage unit. Other transformations of physical media are possible without departing from the scope and spirit of the present description, with the foregoing examples provided only to facilitate this description. The server computer 602 can further read information from the storage device 718 by detecting the physical states or characteristics of one or more particular locations within the physical storage units.

In addition to the mass storage device 718 described above, the server computer 602 can have access to other computer-readable storage media to store and retrieve information, such as program modules, data structures, or other data. It should be appreciated by those skilled in the art that computer-readable storage media is any available media that provides for the non-transitory storage of data and that can be accessed by the server computer 602. In some examples, one or more of the operations performed by the network 104 and or any components included therein, may be supported by one or more devices similar to server computer 602. Stated otherwise, some or all of the operations performed by the network 104, and or any components included therein, may be performed by one or more computer devices operating in a cloud-based arrangement.

By way of example, and not limitation, computer-readable storage media can include volatile and non-volatile, removable and non-removable media implemented in any method or technology. Computer-readable storage media includes, but is not limited to, RAM, ROM, erasable programmable ROM (“EPROM”), electrically-erasable programmable ROM (“EEPROM”), flash memory or other solid-state memory technology, compact disc ROM (“CD-ROM”), digital versatile disk (“DVD”), high definition DVD (“HD-DVD”), BLU-RAY, or other optical storage, magnetic cassettes, magnetic tape, magnetic disk storage or other magnetic storage devices, or any other medium that can be used to store the desired information in a non-transitory fashion.

As mentioned briefly above, the storage device 718 can store an operating system 720 utilized to control the operation of the server computer 602. According to one embodiment, the operating system comprises the LINUX operating system. According to another embodiment, the operating system comprises the WINDOWS® SERVER operating system from MICROSOFT Corporation of Redmond, Washington. According to further embodiments, the operating system can comprise the UNIX operating system or one of its variants. It should be appreciated that other operating systems can also be utilized. The storage device 718 can store other system or application programs and data utilized by the server computer 602.

In one embodiment, the storage device 718 or other computer-readable storage media is encoded with computer-executable instructions which, when loaded into the server computer 602, transform the computer from a general-purpose computing system into a special-purpose computer capable of implementing the embodiments described herein. These computer-executable instructions transform the server computer 602 by specifying how the CPUs 704 transition between states, as described above. According to one embodiment, the server computer 602 has access to computer-readable storage media storing computer-executable instructions which, when executed by the server computer 602, perform the various processes described above with regard to FIGS. 1-4. The server computer 602 can also include computer-readable storage media having instructions stored thereupon for performing any of the other computer-implemented operations described herein.

The server computer 602 can also include one or more input/output controllers 716 for receiving and processing input from a number of input devices, such as a keyboard, a mouse, a touchpad, a touch screen, an electronic stylus, or other type of input device. Similarly, an input/output controller 716 can provide output to a display, such as a computer monitor, a flat-panel display, a digital projector, a printer, or other type of output device. It will be appreciated that the server computer 602 might not include all of the components shown in FIG. 6, can include other components that are not explicitly shown in FIG. 6, or might utilize an architecture completely different than that shown in FIG. 6.

As described herein, the server computer 602 may comprise a network device (e.g., server computer 602 etc.). The server computer 602 may include one or more hardware processors (e.g., processors such as a CPU 704) configured to execute one or more stored instructions. The processor(s) may comprise one or more cores. Further, the server computer 602 may include one or more network interfaces configured to provide communications between the server computer 602 and other devices, such as the communications between server(s) 106 and ToR(s) 114, and/or ToR(s) 114 and border router(s) 116, etc. The network interfaces may include devices configured to couple to personal area networks (PANs), wired and wireless local area networks (LANs), wired and wireless wide area networks (WANs), and so forth. For example, the network interfaces may include devices compatible with Ethernet, Wi-Fi™, and so forth.

The programs 722 may comprise any type of programs or processes to perform the techniques described in this disclosure for streamlined routing and connectivity in data centers that utilize automated containerized networking. The programs 722 may enable the server computer 602 to perform various operations.

While the invention is described with respect to the specific examples, it is to be understood that the scope of the invention is not limited to these specific examples. Since other modifications and changes varied to fit particular operating requirements and environments will be apparent to those skilled in the art, the invention is not considered limited to the example chosen for purposes of disclosure, and covers all changes and modifications which do not constitute departures from the true spirit and scope of this invention.

Although the application describes embodiments having specific structural features and/or methodological acts, it is to be understood that the claims are not necessarily limited to the specific features or acts described. Rather, the specific features and acts are merely illustrative some embodiments that fall within the scope of the claims of the application.

WHAT IS CLAIMED IS:

1. A method implemented by a network device of a network, the method comprising:
receiving, from a server within the network, a first probe comprising first information associated with the server, the first information including one or more first prefixes; storing, in memory of the network device, the first information in association with the server; generating, based on the first information, an advertisement indicating reachability of the server; and advertising the reachability of the server to one or more other network devices, the advertisement including the one or more first prefixes.

2. The method of claim 1, further comprising:
receiving, from the server, a second probe comprising second information associated with the server, the second information including one or more second prefixes; determining that at least one prefix of the one or more first prefixes is not included in the one or more second prefixes; determining that a time period associated with the server has expired; and updating the memory of the network device to remove the at least one prefix.

3. The method of claim 1, further comprising:
receiving, from the server, a second probe comprising second information associated with the server, the second information including one or more second prefixes; determining that at least one prefix of the one or more first prefixes is not included in the one or more second prefixes; receiving, from a second server, a third probe comprising third information, the third information including the at least one prefix; updating, based at least in part on the second probe and the third probe, the memory to remove an association between the at least one prefix and the server; and storing, in the memory, a second association between the at least one prefix and the second server.

4. The method of claim 1, wherein the one or more first prefixes comprise one or more of:
an IPv6 prefix; an IPv4 prefix; an SRv6 Locator; or one or more SRv6 SIDs associated with one or more virtual machines, applications, or containers executing on the server.

5. The method of claim 1, further comprising:
determining that a second probe has not been received from the server and that a time period associated with the server has expired; and updating the memory of the network device to remove the one or more first prefixes.

6. The method of claim 1, further comprising:
receiving, from one or more second servers, one or more second probes comprising one or more second prefixes; aggregating the one or more first prefixes and the one or more second prefixes to create aggregated prefixes; and generating the advertisement, wherein the advertisement comprises at least a portion of the aggregated prefixes.

7. The method of claim 1, wherein advertising comprises redistributing the advertisement via a routing protocol of the network, the routing protocol comprising border gateway protocol (BGP), open shortest path first (OSPF), or intermediate system to intermediate system (ISIS).

8. A method implemented by a server within a network, the method comprising:
determining, by the server, one or more prefixes associated with the server; generating, by the server, a probe comprising information associated with the server, the information including the one or more prefixes; and sending, by the server and based on a time interval, the probe to a first network device and a second network device, wherein the first network device and the second network device redistribute the information to the network.

9. The method of claim 8, wherein the probe is a link layer discovery protocol (LLDP) probe.

10. The method of claim 9, wherein generating the probe further comprises adding a TLV field to the probe, the TLV field including a TLV type, a TLV length, a unique identifier, a hold timer, and the one or more prefixes.

11. The method of claim 8, wherein the one or more prefixes are encoded as a block of prefixes within the probe.

12. The method of claim 8, wherein generating the probe further comprises adding a TLV field to the probe, the TLV field comprising metadata associated with applications or containers corresponding to the one or more prefixes.

13. The method of claim 8, wherein the one or more prefixes comprise one or more of an IPv6 prefix, an IPv4 prefix, or an SRv6 Locator.

14. The method of claim 8, further comprising:
by the server, a new prefix associated with a new container, a new virtual machine, or a new application running on the server; and by the server, a second probe comprising second information, the second information including the new prefix.

15. The method of claim 8, wherein the one or more prefixes comprise identifiers associated with one or more applications, virtual machines, or containers executing on the server.

16. The method of claim 8, wherein the first network device comprises a top of rack router that is configured to redistribute the one or more prefixes using one or more routing protocols of the network.

17. A system comprising:
one or more processors; and one or more computer-readable media storing instructions that, when executed by the one or more processors, cause the one or more processors to perform operations comprising:
determining, by a server, one or more prefixes associated with the server; generating, by the server, a probe comprising information associated with the server, the information including the one or more prefixes; and sending, by the server and based on a time interval, the probe to a first network device and a second network device, wherein the first network device and the second network device redistribute the information.

18. The system of claim 17, wherein the one or more prefixes comprise one or more of an IPv6 prefix, an IPv4 prefix, or an SRv6 Locator.

19. The system of claim 17, wherein the probe comprises a LLDP probe and generating the probe further comprises adding a TLV field to the probe, the TLV field including a TLV type, a TLV length, a unique identifier, a hold timer, and the one or more prefixes.

20. The system of claim 17, wherein the one or more prefixes are encoded as a block of prefixes within the probe.
